(19) United States
(12) Patent Application Publication
(10) Pub. No.: US 2022/0355435 A1
(43) Pub. Date: Nov. 10, 2022

(54) FIXED-ABRASIVE PAD USING VERTICALLY ALIGNED CARBON NANOTUBES AND FABRICATION METHOD FOR THE SAME

(71) Applicant: KOREA ADVANCED INSTITUTE OF SCIENCE AND TECHNOLOGY, Daejeon (KR)

(72) Inventors: Sanha Kim, Daejeon (KR); Sukkyung Kang, Daejeon (KR); Seong Jae Kim, Daejeon (KR); Ji-hun Jeong, Daejeon (KR)

(21) Appl. No.: 17/526,134

(22) Filed: Nov. 15, 2021

(30) Foreign Application Priority Data
May 7, 2021 (KR) 10-2021-0058912
Jul. 7, 2021 (KR) 10-2021-0089224

(51) Int. Cl. B24B 37/24

(52) U.S. Cl. CPC B24B 37/24; B82Y 30/00

(57) ABSTRACT

Various embodiments of the present disclosure relate to a fixed-abrasive pad using vertically aligned carbon nanotubes and a fabrication method for the same. The fixed-abrasive pad may include a pad made of a polymer material; and vertically aligned carbon nanotubes (VACNT) which are configured such that one side thereof is impregnated into the pad and the other side protrudes from the pad.

### CROSS-REFERENCE TO RELATED APPLICATION

This application claims the benefit under 35 USC 119(a) of Korean Patent Applications No. 10-2021-0058912, filed May 7, 2021, and Korean Patent Applications No. 10-2021-0089224, filed Jul. 7, 2021, the entire disclosure of which is incorporated herein by reference for all purposes.

### FIELD

Various embodiments of the present disclosure relate to a fixed-abrasive pad and a fabrication method for the same.

### BACKGROUND

A mechanical polishing process using a hard and fine abrasive is widely used in various industrial fields. For example, the mechanical polishing process may be used to smooth the rough surface of metal machine parts, or may be used to precisely process the surface of a portable electronic device housing. Also, the mechanical polishing processes can be used to planarize semiconductor wafers by being combined with a chemical reaction.

Currently, abrasives and pads used in the polishing process may be classified into a fixed abrasive pad and a loose abrasive pad depending on whether or not abrasive particles are fixed to the pad.

FIG. 1 shows a polishing process using a fixed-abrasive pad according to a prior art, and FIG. 2 shows a polishing process using a loosed-abrasive pad according to a prior art.

As shown in FIG. 1, the fixed-abrasive pad is configured such that an abrasive 130 is fixed to a pad 110. One example of the fixed-abrasive pad is sandpaper. In the case of using the fixed-abrasive pad, since the abrasive is fixed, the polishing process is simple and efficient, so that it is convenient to use the abrasive and a relatively small amount of the abrasive is lost. However, it is difficult to fix uniformly small-sized abrasive particles to the pad. Also, since the size and/or height of the abrasive particle fixed to the pad have large deviations, it is difficult to precisely process a surface. In order to compensate the problem of the polishing precision of the fixed-abrasive pad, a loosed-abrasive pad process shown in FIG. 2 was developed.

As shown in FIG. 2, in the loosed-abrasive pad, an abrasive 230 is not fixed to a pad and is injected between the pad 210 and a substrate 220 which is an article to be processed, so that the article can be polished. The loosed-abrasive pad is being used in a polishing process which requires precise planarization such as a chemical mechanical polishing (CMP) process.

### SUMMARY

### Technical Problem

For the processing of electronic devices and semiconductor parts, the loosed-abrasive pad is used to satisfy a required high precision. However, in a method which uses the loosed-abrasive pad, abrasive particles agglomerate between the pad and the article to be processed, which may cause scratches on the article to be processed, and a cleaning process which removes the abrasive particles is required after the process. That is, the method which uses the loosed-abrasive pad has disadvantages that it has more complex and inconvenient steps than those of a method which uses the fixed-abrasive pad. Also, the method which uses the loosed-abrasive pad generates a large amount of waste water due to the cleaning process, and thus, it may adversely affect the environment.

Accordingly, various embodiments of the present disclosure disclose a fixed-abrasive pad using vertically aligned carbon nanotubes (VACNT) and a fabrication method for the same.

Various embodiments of the present disclosure disclose the fixed-abrasive pad having high polishing precision and convenient usability by using the vertically aligned carbon nanotubes (VACNT).

The technical problem to be overcome in this document is not limited to the above- mentioned technical problems. Other technical problems not mentioned can be clearly understood from those described below by a person having ordinary skill in the art.

### Technical Solution

One embodiment is a fixed-abrasive pad including: a pad made of a polymer material; and vertically aligned carbon nanotubes (VACNT) which are configured such that one side thereof is impregnated into the pad and the other side protrudes from the pad.

A diameter of the VACNT has a size between one nanometer (nm) and 500 nanometers (nm).

A length of the VACNT is maximally 1,000 micrometers (μm). A length of the portion protruding from the pad is maximally 500 nanometers (nm).

The pad is the fixed-abrasive pad made of polyurethane.

Another embodiment is a fabrication method for the fixed-abrasive pad. The fabrication method includes: synthesizing the vertically aligned carbon nanotubes (VACNT) on a substrate; impregnating the VACNT into polyurethane; removing the substrate; and protruding one side of the VACNT.

The synthesizing the VACNT on a substrate includes: depositing a catalyst layer on the substrate by physical vapor deposition; and synthesizing the VACNT on the substrate on which the catalyst layer has been deposited, by chemical vapor deposition.

A diameter of the VACNT has a size between one nanometer (nm) and 500 nanometers (nm).

A length of the VACNT is maximally 1,000 micrometers (μm).

The one side of the VACNT is protruded by using a plasma etching process.

A protrusion length of the one side of the VACNT is adjusted depending on conditions of the plasma etching process.

The protrusion length of the one side of the VACNT is maximally 500 nanometers (nm).

### Advantageous Effects

According to various embodiments of the present disclosure, it is possible to provide a fixed-abrasive pad having high polishing precision by using vertically aligned carbon nanotubes (VACNT). Also, by using the carbon nanotubes having excellent mechanical properties, it is possible to provide a fixed-abrasive pad which has high polishing performance and is used semi-permanently.

The fixed-abrasive pad using the vertically aligned carbon nanotubes according to various embodiments of the present disclosure can be used throughout the industries requiring precise surface processing.

The fixed-abrasive pad using the vertically aligned carbon nanotubes according to various embodiments of the present disclosure does not require an additional process (e.g., a cleaning process) for removing abrasives, thereby reducing process time and improving productivity.

The fixed-abrasive pad using the vertically aligned carbon nanotubes according to various embodiments of the present disclosure does not generate waste water during the polishing process and can be used semi-permanently, thereby improving problems of environmental pollution.

Advantageous effects that can be obtained from the present disclosure are not limited to the above-mentioned effects. Further, other unmentioned effects can be clearly understood from the following descriptions by those skilled in the art to which the present disclosure belongs.

### BRIEF DESCRIPTION OF THE DRAWINGS

FIG. 1 is a conceptual view of a polishing process using a fixed-abrasive pad according to a prior art;

FIG. 2 is a conceptual view of a polishing process using a loosed-abrasive pad according to a prior art.

FIG. 3A is a structural view of a fixed-abrasive pad impregnated with vertically aligned carbon nanotubes according to various embodiments of the present disclosure;

FIG. 3B is a conceptual view of a polishing process using the fixed-abrasive pad impregnated with the vertically aligned carbon nanotubes according to various embodiments of the present disclosure;

FIG. 4 is a flowchart of a method for fabricating the fixed-abrasive pad impregnated with the vertically aligned carbon nanotubes according to various embodiments of the present disclosure;

FIG. 5 is a view showing the method for fabricating the fixed-abrasive pad impregnated with the vertically aligned carbon nanotubes according to various embodiments of the present disclosure;

FIG. 6 shows scanning electron microscope (SEM) images of the fixed-abrasive pad impregnated with the vertically aligned carbon nanotubes according to various embodiments of the present disclosure;

FIG. 7A is a view of an experimental environment in which a copper plate is polished by using the fixed-abrasive pad impregnated with the vertically aligned carbon nanotubes according to various embodiments of the present disclosure;

FIGS. 7B and 7C show experimental results of polishing the copper plate by using the fixed-abrasive pad impregnated with the vertically aligned carbon nanotubes according to various embodiments of the present disclosure; and

FIG. 8 shows the experimental results of polishing a copper wafer by using the fixed-abrasive pad impregnated with the vertically aligned carbon nanotubes according to various embodiments of the present disclosure and by using conventional abrasive pads.

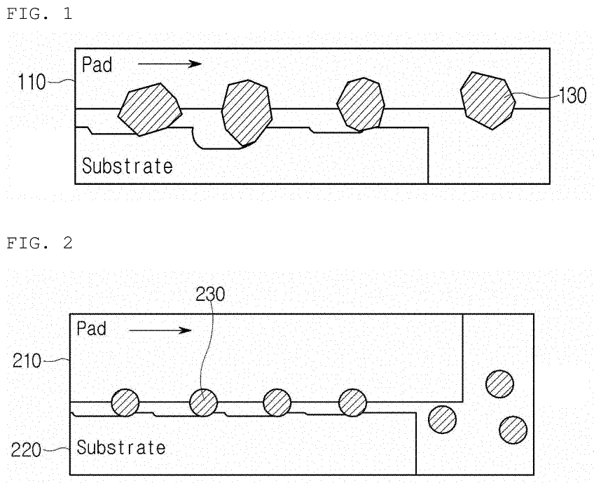

With regard to the description of the drawings, the same or similar reference numerals may be used for the same or similar components.

### DETAILED DESCRIPTION

Hereinafter, various embodiments will be described in detail with reference to the accompanying drawings.

The same or similar elements are denoted by the same reference numerals irrespective of the drawing numerals, and repetitive description thereof may be omitted.

While terms including ordinal numbers such as the first and the second, etc., can be used to describe various components, the components are not limited by the terms mentioned above. The terms are used only for distinguishing between one component and other components.

In the case where a component is referred to as being “connected” or “accessed” to another component, it should be understood that not only the component is directly connected or accessed to the other component, but also there may exist another component between them. Meanwhile, in the case where a component is referred to as being “directly connected” or “directly accessed” to another component, it should be understood that there is no component therebetween.

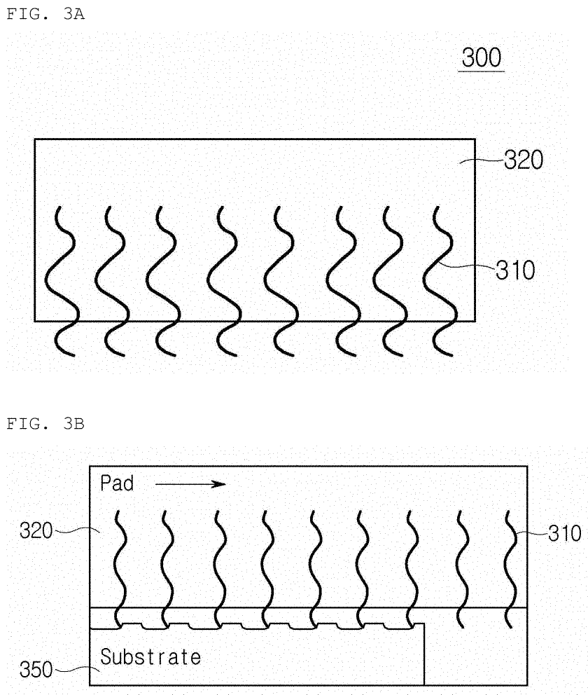

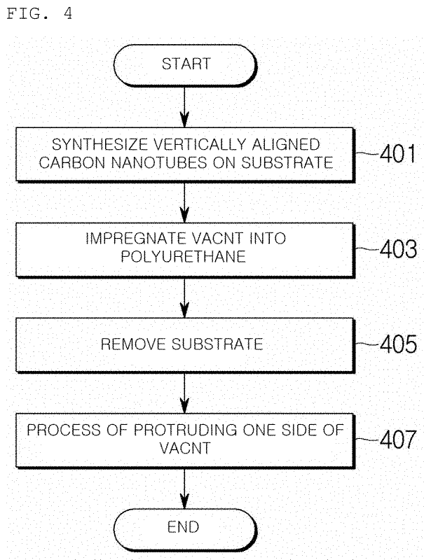

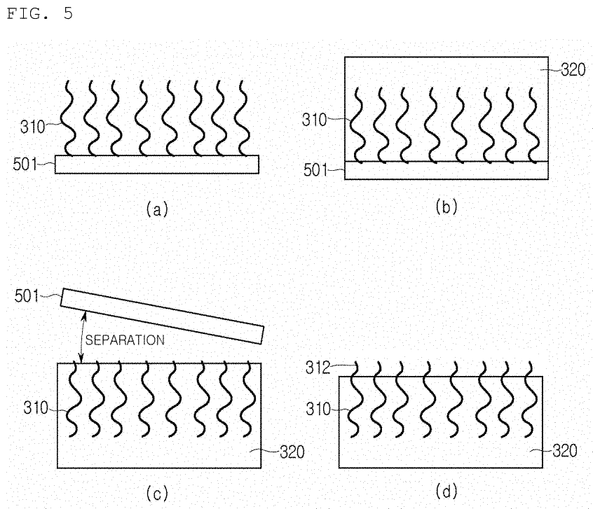

FIG. 3A is a structural view of a fixed-abrasive pad impregnated with vertically aligned carbon nanotubes according to various embodiments of the present disclosure. FIG. 3B is a conceptual view of a polishing process using the fixed-abrasive pad impregnated with the vertically aligned carbon nanotubes according to various embodiments of the present disclosure.

Referring to FIG. 3A, a fixed-abrasive pad 300 according to various embodiments of the present disclosure may be formed in the form that a pad 320 is impregnated with vertically aligned carbon nanotubes (VACNT) 310. For example, the fixed-abrasive pad 300 may be configured such that one side of the VACNT 310 is impregnated into the pad 320 and fixed, and the other side is exposed to the outside of the pad 320.

According to the embodiment, the VACNT 310 may be multi-walled tubes whose diameter can be adjusted. For example, the diameter of the VACNT 310 may be adjusted to a desired size between about one nanometer (nm) and 500 nanometers in a fabrication step of the fixed-abrasive pad 300.

According to the embodiment, the length of the VACNT 310 may be adjusted from minimally several micrometers (μm) to maximally one millimeter (mm).

According to the embodiment, a portion of the VACNT 310, which is exposed to the outside of the pad 320, that is to say, a portion protruding from the pad 320, may have a minimum length of one micrometer to a maximal length of 500 nanometers.

According to the embodiment, the portion of the VACNT 310, which is exposed to the outside of the pad 320, that is to say, the portion protruding from the pad 320, may be processed so as not to have a height deviation or be processed to have a very small height deviation.

According to the embodiment, the pad 320 may be made of a polymer material, for example, may be made of polymer material polyurethane.

According to various embodiments of the present disclosure, since the fixed-abrasive pad 300 is configured as described above, a load applied to a workpiece to be polished can be uniformly distributed, so that very precise polishing is possible. For example, in the fixed-abrasive pad 300, the VACNT 310 has a small diameter and a small deviation in size and height. Accordingly, as shown in FIG. 3B, when a substrate 350 is polished, a load applied to the substrate 350 in the fixed-abrasive pad 300 is uniformly distributed, so that very small and uniform surface scratches are formed, enabling very precise polishing.

As described above, according to various embodiments of the present disclosure, the fixed-abrasive pad 300 includes carbon nanotubes having superb mechanical properties that include high strength than that of steel, and thus, has excellent polishing performance and can be universally used regardless of the material of the workpiece.

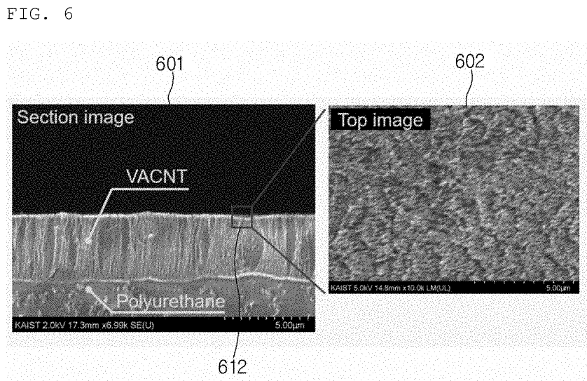

FIG. 4 is a flowchart of a method for fabricating the fixed-abrasive pad impregnated with the vertically aligned carbon nanotubes according to various embodiments of the present disclosure. FIG. 5 is a view showing the method for fabricating the fixed-abrasive pad impregnated with the vertically aligned carbon nanotubes according to various embodiments of the present disclosure.

Referring to FIG. 4, the method for fabricating the fixed-abrasive pad 300 may include a step 401 of synthesizing the VACNT 310 on the substrate.

According to the embodiment, the synthesis step includes depositing a Fe/Al203 catalyst layer on a substrate or metal foil by physical vapor deposition (PDV), and includes, as shown in (a) of FIG. 5, synthesizing the VACNT 310 on the substrate 501 or metal foil on which the Fe/Al203 catalyst layer is deposited, by chemical vapor deposition (CVD). According to the embodiment, the VACNT 310 may be multi-walled tubes whose diameter and/or length is adjustable. For example, the diameter of the VACNT 310 may be adjusted to a desired size from about one nanometer (nm) to 500 nanometers. For another example, the length of the VACNT 310 may be adjusted from minimally several micrometers (μm) to maximally one millimeter (mm). As such, in the synthesis step, nanowires having a high slenderness ratio of up to 200,000 can be uniformly grown on the substrate. In particular, since the carbon nanotubes 310 are synthesized by using the chemical vapor deposition (CVD), large-area growth is possible. Also, when growing the VACNT 310 on a patterned substrate or metal foil, the VACNT 310 grow according to the pattern shape, so that customization is possible in compliance with the purpose. According to the embodiment, in order to minimize the height deviation of one side of the VACNT 310, a flat substrate can be used.

The method for fabricating the fixed-abrasive pad 300 may include a step 403 of impregnating the VACNT 310 into polyurethane. For example, as shown in (b) of FIG. 5, uniformly grown VACNT 310 may be impregnated into the surface of the polyurethane 320 material. Here, it is important to allow the polyurethane to permeate well without pores between the VACNT 310. According to the embodiment, the polyurethane 320 can be referred to as the pad.

The method for fabricating the fixed-abrasive pad 300 may include a step 450 of removing the substrate. For example, the step 450 of removing the substrate may be a step of separating, as shown in (c) of FIG. 5, the substrate 501 or the metal foil on which the VACNT 310 have grown. Since there is no pore in step 403 of impregnating the VACNT 310 into polyurethane, the surface where the VACNT 310 and the polyurethane 320 coexist (for example, the surface in contact with the substrate 501) has the same shape as that of the substrate or metal foil. Accordingly, when the substrate has a flat shape, since the VACNT 310 and the polyurethane have the same height, the VACNT 310 has no height deviation.

The method for fabricating the fixed-abrasive pad 300 may include a process step 407 of protruding one side of the VACNT 310. For example, as shown in (d) of FIG. 5, the protrusion process step 407 of protruding a portion 312 of the VACNT 310 and of exposing to the outside of the polyurethane 320. According to the embodiment, the portion 312 of the VACNT 310 may be made to protrude by cutting the polyurethane 320 through a plasma etching process. For example, the portion 312 of the VACNT 310 can be made to protrude through an O₂ plasma etching process. This is merely an example, and various embodiments of the present disclosure are not limited thereto. The length of the portion 312 protruding from the VACNT 310 may be adjusted depending on the conditions of the plasma etching process. In the fixed-abrasive pad 300 according to the embodiment of the present disclosure, only the portion 312 of the VACNT 310 obtained by imitating a sprout of a plant protrudes and the other portion is impregnated with the polyurethane 320, so that the carbon nanotube serving as an abrasive can be firmly fixed. Also, there is no or very small height deviation of the protruding portion of the carbon nanotube, and the protruding portions are uniformly distributed over the entire area of the pad made of the polyurethane 320. Therefore, high polishing performance can be achieved.

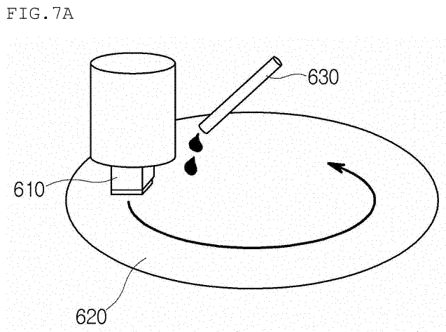

FIG. 6 shows scanning electron microscope (SEM) images of the fixed-abrasive pad impregnated with the vertically aligned carbon nanotubes according to various embodiments of the present disclosure.

A left image 601 of FIG. 6 is a photograph showing a cross-section of the fixed-abrasive pad 300, and a right image 602 is a photographing showing a portion 612 of the top surface of the fixed-abrasive pad 300. The top surface of the fixed-abrasive pad 300 is the protruding portion of the VACNT 310.

Referring to FIG. 6, it can be seen that a coexistence layer in which the polyurethane and VACNT 310 coexist is provided on a layer in which only the underlying polyurethane exists. Looking more closely the coexistence layer, it can be seen that the polyurethane permeates well without pores between the VACNT 310, and thus, the VACNT 310 are strongly impregnated.

As described above, in the fixed-abrasive pad 300 according to various embodiments of the present disclosure, since only a portion of the carbon nanotubes 310 are impregnated and the other portion protrudes, it is possible to solve a problem that, as with a conventional fixed-abrasive pad, the abrasive falls off the pad during polishing. Also, in the fixed-abrasive pad 300 according to various embodiments of the present disclosure, the abrasion resistance of the pad can be increased due to the structure of the VACNT, and thus the fixed-abrasive pad 300 can be used semi-permanently. Also, since a maximum force transmitted to each carbon nanotube is limited due to the polyurethane made of a mechanically soft polymer, a defect rate including scratch, etc., can be reduced.

As described above, when the fixed-abrasive pad 300 according to various embodiments of the present disclosure is used, mechanical polishing can be performed more precisely than a conventional fixed-abrasive pad and a loosed-abrasive pad.

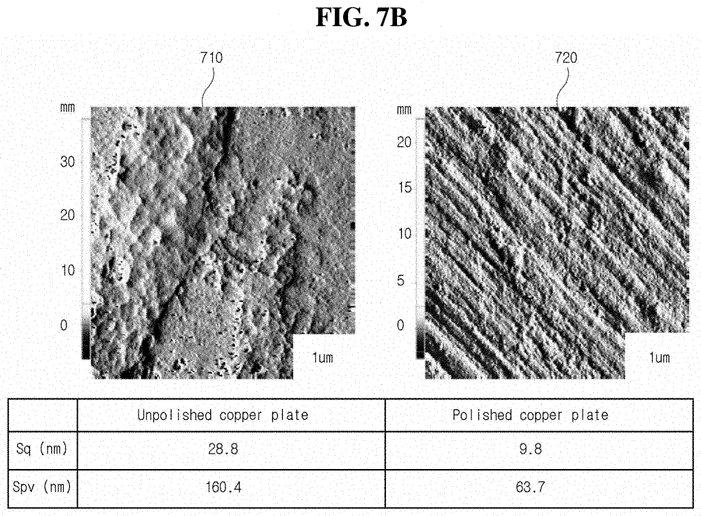

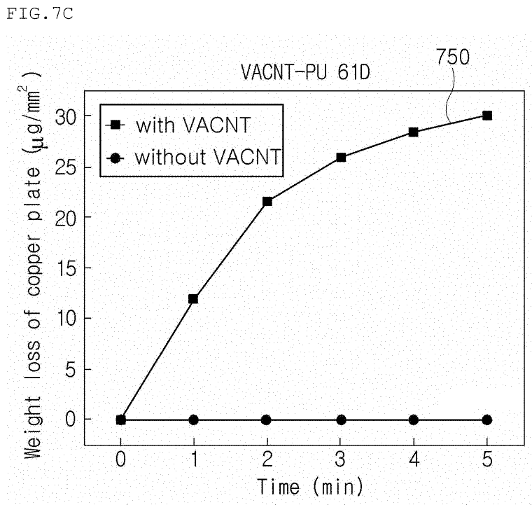

FIG. 7A is a view of an experimental environment in which a copper plate is polished by using the fixed-abrasive pad impregnated with the vertically aligned carbon nanotubes according to various embodiments of the present disclosure. FIG. 7B and 7C show experimental results of polishing the copper plate by using the fixed-abrasive pad impregnated with the vertically aligned carbon nanotubes according to various embodiments of the present disclosure.

Referring to FIG. 7A, in order to experiment the polishing performance of the fixed-abrasive pads 300 and 610 according to various embodiments of the present disclosure, a copper plate 620 having a rough surface is polished. Here, the fixed-abrasive pads 300 and 610 according to various embodiments of the present disclosure may be referred to as polishing pads. For more accurate experiments, the polishing experiments is carried out by injecting only purified water (DI water) 630 without adding other chemicals.

FIG. 7B shows a roughness of the copper plate surface before the polishing experiment and the roughness of the copper plate surface after the polishing experiment. Referring to FIG. 7B, as a result of polishing the copper plate in the experimental environment as described in FIG. 7A, it can be seen that the surface of the copper plate is very rough as shown in the left image 710 before the polishing experiment, and the roughness of the copper plate surface is reduced after the polishing experiment as shown in the right image 720. Also, as a result of measuring the roughness Sq of the copper plate surface, it can be seen that the surface roughness Sq is 28.8 nm before the polishing experiment and the surface roughness is reduced to 9.8 nm after the polishing experiment. Also, as a result of measuring a peak to valley (P-V) Spv which indicates a flatness of the copper plate surface, it can be seen that the P-V Spv is 160.4 nm before the polishing experiment and the P-V Spv is reduced to 63.7 nm after the polishing experiment.

FIG. 7C shows a weight reduction amount of the copper plate during the polishing experiment. Referring to FIG. 7C, it can be seen that the weight of the copper plate is reduced every minute when the copper plate is polished in the experimental environment as described in FIG. 7A. For example, in the case where the polishing is performed by using a fixed-abrasive pad 610 according to various embodiments of the present disclosure, it can be seen that when one minute elapses after starting the polishing as shown in a shown graph 750, the weight of the copper plate is reduced by about 10 μg/mm² to 15 μg/mm², and when five minutes elapse after starting the polishing, the weight of the copper plate is reduced by about 30 μg/mm².

On the other hand, when the copper plate is polished only by the polyurethane pad without the vertically aligned carbon nanotubes, it can be seen that the weight of the copper plate remains the same. In this case, when the fixed-abrasive pad 610 impregnated with the vertically aligned carbon nanotubes proposed in the present disclosure is used, the polishing performance for the copper plate is excellent. However, when the polishing is performed only by the pad without the vertically aligned carbon nanotubes, it may mean that the copper plate is not polished at all.

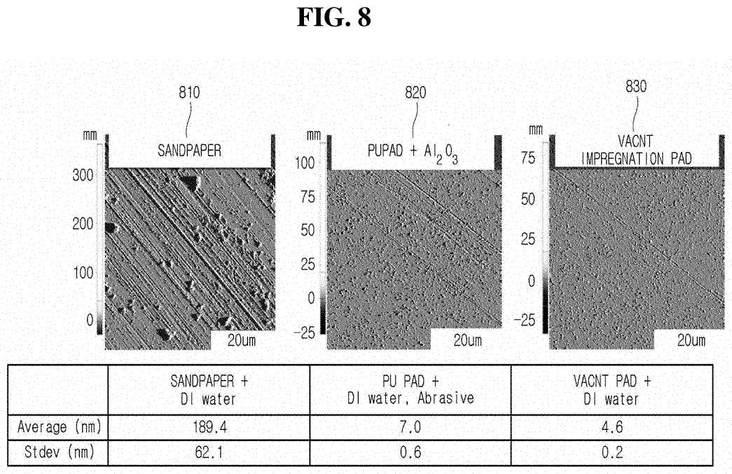

FIG. 8 shows the experimental results of polishing a copper wafer by using the fixed-abrasive pad impregnated with the vertically aligned carbon nanotubes according to various embodiments of the present disclosure and by using conventional abrasive pads.

As shown in FIG. 8, the polishing experiment is performed when a sandpaper 810, that is, a conventional fixed-abrasive pad, is used, when polyurethane (PU) pad, that is, a loosed-abrasive pad, and alumina (AI₂O₃) 820 are used, and when a fixed-abrasive pad 830 impregnated with the VACNT proposed in the present disclosure is used. Here, in order to experiment the performance of each abrasive pad, a copper wafer (Cu wafer) is polished. For more accurate experiments, the polishing experiments is carried out by injecting only purified water without adding other chemicals. Here, the sizes of the abrasive particles of the abrasive pads used in the experiment are different from each other. That is, the size of silicon carbide, i.e., an abrasive particle of the sandpaper, is about five micrometers, and the particle size of the alumina is 80 nanometers. Also, the size of the VACNT proposed in the present disclosure is 20 nm.

FIG. 8 shows the roughness of the copper surface polished by using each abrasive pad and shows a polishing depth. Referring to FIG. 8, as a result of polishing by using the sandpaper 810, that is a conventional fixed-abrasive pad, it can be found that the roughness Rq of the copper surface is 64 nm, the polishing depth is 189.4 nm on average, and a standard deviation is 62.1 nm. Also, as a result of polishing by using the alumina 820, that is a loosed-abrasive pad, it can be found that the roughness Rq of the copper surface is 10.6 nm, the polishing depth is 7.0 nm on average, and the standard deviation is 0.6 nm.

Meanwhile, as a result of polishing by using the fixed-abrasive pad 830 impregnated with the VACNT proposed in the present disclosure, it can be seen that the roughness Rq of the copper surface is 7.1 nm, the polishing depth is 4.6 nm on average, and the standard deviation is 0.2 nm. That is, it can be understood that the polishing performance of the fixed-abrasive pad 830 impregnated with the VACNT proposed in the present disclosure is superior to the polishing performance of the sandpaper 810 and the alumina 820.

As described above, when the fixed-abrasive pad impregnated with the VACNT is used, the surface of an article can be precisely polished and an additional process (e.g., a cleaning process) for removing the abrasive is not required. Therefore, process time can be shortened and productivity can be improved. Also, since the abrasive does not need to be removed, the fixed-abrasive pad does not generate waste water during the polishing process and can be used semi-permanently, thereby improving problems of environmental pollution.

As described above, the fixed-abrasive pad according to various embodiments of the present disclosure may be used in various industrial fields requiring surface processing. For example, the fixed-abrasive pad can be applied in various fields throughout the industries requiring surface processing such as electronic products requiring precise surface polishing, vehicle housing processing, surface processing of materials such as jewelry where aesthetics of appearance is important, and wafer planarization processing in a semiconductor processing, etc.

REFERENCE NUMERALS

| 110: Pad | 130: Abrasive |
|---|---|
| 210: Pad | 220: Substrate |
| 230: Abrasive | 300: Fixed-abrasive pad |
| 310: Vertically aligned carbon nanotube(s) (VACNT) | |
| 320: Pad | 350: Substrate |

What is claimed is:

1. A fixed-abrasive pad comprising:
a pad made of a polymer material; and
vertically aligned carbon nanotubes (VACNT) which are configured such that one side thereof is impregnated into the pad and the other side protrudes from the pad.

2. The fixed-abrasive pad of claim 1, wherein a diameter of the VACNT has a size between one nanometer (nm) and 500 nanometers (nm).

3. The fixed-abrasive pad of claim 2, wherein a length of the VACNT is maximally 1,000 micrometers (μm), and wherein a length of the portion protruding from the pad is maximally 500 nanometers (nm).

4. The fixed-abrasive pad of claim 1, wherein the fixed-abrasive pad is made of polyurethane.

5. A fabrication method of the fixed-abrasive pad, the fabrication method comprising:
synthesizing the vertically aligned carbon nanotubes (VACNT) on a substrate;
impregnating the VACNT into polyurethane;
removing the substrate; and
protruding one side of the VACNT.

6. The fabrication method of claim 5, wherein the synthesizing the VACNT on a substrate comprises:
depositing a catalyst layer on the substrate by physical vapor deposition; and
synthesizing the VACNT on the substrate on which the catalyst layer has been deposited, by chemical vapor deposition.

7. The fabrication method of claim 6, wherein a diameter of the VACNT has a size between one nanometer (nm) and 500 nanometers (nm).

8. The fabrication method of claim 6, wherein a length of the VACNT is maximally 1,000 micrometers (μm).

9. The fabrication method of claim 5, wherein the one side of the VACNT is protruded by using a plasma etching process.

10. The fabrication method of claim 9, wherein a protrusion length of the one side of the VACNT is adjusted depending on conditions of the plasma etching process.

11. The fabrication method of claim 10, wherein the protrusion length of the one side of the VACNT is maximally 500 nanometers (nm).
